(19) United States
(12) Patent Application Publication
(10) Pub. No.: US 2003/0147034 A1
(43) Pub. Date: Aug. 7, 2003

(54) Sealing agent for LC dropping method for LCD panels

(75) Inventor: Kazuyuki Kojima, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KYORITSU CHEMICAL & CO., LTD, Tokyo (JP)

(21) Appl. No.: 10/058,439

(22) Filed: Jan. 28, 2002

(51) Int. Cl. G02F 1/1339

(52) U.S. Cl. 349/153

(57) ABSTRACT

This invention provides a sealing agent for LC dropping method for LCD panels with the least contamination of liquid crystals and the least outgassing preferably in vacuo. Disclosed is a sealing agent for LC dropping method for LCD panels which comprises a photosetting component, a thermosetting component and a photosetting agent, characterized in that the reduction in the logarithm of the specific resistance of liquid crystals as determined by Measurement Method A described in the Detailed Description of the Invention is 8% or less, and the change in the phase transition temperature of the liquid crystals as determined by Measurement Method B in the Detailed Description of the Invention is 0.5° C. or less.

### BACKGROUND OF THE INVENTION

1. Description of the Prior Art

As a technique of producing LCD panels, a means called LC (Liquid Crystal) dropping method is known at present, and the sealing agent used in this technique includes the agent described in e.g. Japanese Provisional Patent Publication No. 5759/1997. However, when the conventional sealing agent is used, the resulting panels are poor in reliability under the presence circumstances because of contamination of liquid crystals with the sealing agent, etc.

### SUMMARY OF THE INVENTION

The object of this invention is to provide a sealing agent for LC dropping method for LCD panels with the least contamination of liquid crystals and the least outgassing preferably in vacuo.

That is, this invention relates to a sealing agent for LC dropping method for LCD panels which comprises a photosetting component, a thermosetting component and a photosetting agent, characterized in that the reduction in the logarithm of the specific resistance of liquid crystals as determined by Measurement Method A described in the Detailed Description of the Invention is 8% or less, and the change in the phase transition temperature of the liquid crystals as determined by Measurement Method B in the Detailed Description of the Invention is 0.5° C. or less.

Further, the present invention relates to the sealing agent characterized in that the reductions in weight at room temperature and 150° C. as determined by Measurement Method C described in the Detailed Description of the Invention are 0.05 weight % or less and 0.5 weight % or less, respectively.

### BRIEF DESCRIPTION OF THE DRAWING

FIG. 1 shows the method of using the sealing agent of the invention.

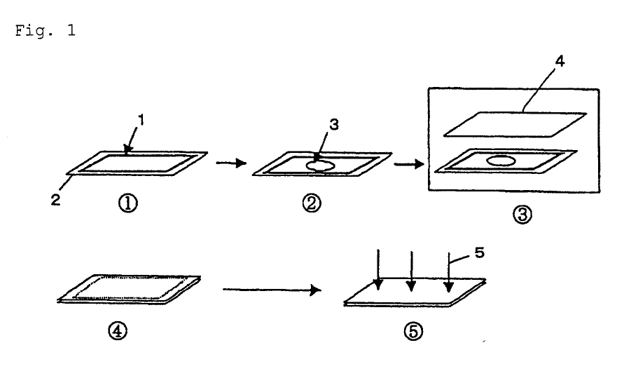

### DETAILED DESCRIPTION OF THE INVENTION

Although the photosetting component contained in the sealing agent of this invention is not particularly limited, known photosetting components used in sealing agents, for example UV-curing components can be used. The photosetting component is preferably an oligomer having a relatively large molecular weight (preferably in the range of 400 to 1000) with opposite polarity to that of liquid crystals used. The photosetting component includes e.g. a partially acrylated (or partially methcrylated) epoxy resin that is a reaction product of bisphenol A type epoxy resin with acrylic acid (or methacrylic acid). The partially acrylated (or partially methcrylated) epoxy resin includes e.g. a partially acrylated (or partially methcrylated) epoxy resin that is a reaction product of bisphenol A type epoxy resin with acrylic acid (or methacrylic acid). This resin is obtained in a usual manner by reacting bisphenol A type epoxy resin with acrylic acid (or methacrylic acid), that is, by reacting 2 equivalents of epoxy group with 0.9 to 1.1 equivalents of carboxylic acid group in the presence of a basic catalyst. Then, to this reaction product are added 4-fold (by weight) excess toluene and an equal volume of pure water, and the mixture is stirred at 60 to 80° C. for 1 hour, then left and separated into organic and aqueous layers, and the aqueous layer is removed. This operation is repeated 3 to 5 times, and finally the organic layer is recovered and then subjected to distillation in vacuo to remove residual toluene. By treatment of reducing water-soluble ionic substances in the manner described above, the partially acrylated (or partially methacrylated) epoxy resin is purified. Preferable examples of the bisphenol A type epoxy resin include Epicoat 828, 834, 1001, 1004 (Yuka Shell Epoxy Co., Ltd.), Epichlone 850, 860, 4055 (Dainippon Ink and Chemicals, Incorporation), etc. Among these raw resins, those resins which were subjected to the treatment of reducing water-soluble ionic substances (referred to hereinafter as highly purifying treatment) are preferable, and for example Epichlone 850S (Dainippon Ink and Chemicals, Incorporation) or the like is preferable.

The thermosetting component contained in the sealing agent of the invention is not particularly limited, but known thermosetting components used in sealing agents can be employed. The thermosetting component includes e.g. bisphenol A type epoxy resin (preferably having a molecular weight of 400 or more). Examples of the bisphenol A type epoxy resin include Epicoat 828, 834, 1001, 1004 (Yuka Shell Epoxy Co., Ltd.), Epichlone 850, 860, 4055 (Dainippon Ink and Chemicals, Incorporation), etc. Among these raw resins, those resins subjected to the treatment of reducing water-soluble ionic substances (referred to hereinafter as highly purifying treatment) are preferable, and for example Epichlone 850S, 860 (Dainippon Ink and Chemicals, Incorporation), etc. are preferably used.

The photo-initiator (photosetting agent) contained in the sealing agent of the invention is not particularly limited, and various photosetting agents can be used. Preferably, the photosetting agent is poor in compatibility with the liquid crystals used, and upon decomposition upon light irradiation, its products are not gasified. For example, mention is made of the following compound, which is available under the trade name EY Resin KR-02 (manufactured by Light Chemical Co., Ltd.):

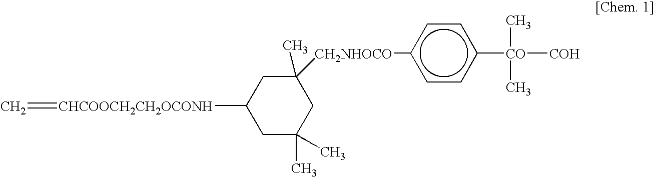

When an epoxy resin is used as the thermosetting component, a potential epoxy-curing agent is preferably contained. The potential curing agent is more preferably the one hardly gasified at the reaction temperature, and specifically the potential curing agent includes A) aromatic amines such as methaphenylene diamine, diaminodiphenyl methane and diaminodiphenyl sulfone, B) dicyandiamide, C) imidazole derivatives represented by Curezole OR, Curezole CN and Curezole AZINE (Shikoku Chemicals Corporation) and D) organic acid dihydrazides. In particular, special organic acid dihydrazides, specifically Amicure-VDH, Amicure-LDH, Amicure-UDH (Ajinomoto Co., Ltd.) are preferable. The method usable for the highly purifying treatment of the potential curing agent involves dissolving it under heating in any one of \mathring{1}methanol, \mathring{2} a mixed solvent of methanol and an organic solvent and \mathring{1} a mixed solvent of methanol and deionized water, then sufficiently stirring the solution, filtering it, repeating the above steps, and drying the filtrate obtained above, to give a purified potential curing agent.

The sealing agent of the invention may be blended with an inorganic filler. Specifically, this inorganic filler includes synthetic silica, talc etc. This component is also subjected if necessary to the highly purifying treatment where the inorganic filler is repeatedly washed with deionized water to give the desired purified product. The sealing agent may be blended with a thixotropic agent for regulating the concentration of the blended solution, a coupling agent for improving adhesion, an additive, and a spacer for securing a predetermined gap. Specifically, the thixotropic agent includes silicic anhydride; the silane-coupling agent for improving adhesion includes vinyl silane, epoxy silane, amino silane, mercapto silane or mixtures thereof; the additive includes modified oligomers composed essentially of butadiene-acrylonitrile copolymers; and the spacer for gapping includes polymer beads adjusted to a predetermined size.

The content of the water-soluble ionic substances in the sealing agent of this invention, in terms of ionic conductivity, is preferably at most 20 μS/cm, more preferably at most 15 μS/cm. This ionic conductivity can be measured by a conductivity meter produced by e.g. Horiba, Ltd. The viscosity of the sealing agent in this invention is preferably in the range of 200,000 to 1,000,000 mPa.s. This viscosity is measured at 25° C. or less by e.g. an EH-type viscometer produced by Toki Sangyo.

This invention is characterized in that after the sealing agent is placed in liquid crystals, the reduction in the logarithm of the specific resistance of the liquid crystals (cured product and liquid) as determined by Measurement Method A below is 8% or less, while the change in the phase transition temperature of the liquid crystals as determined by Measurement Method B below is 0.5° C. or less.

Measurement Method A

0.3 g of the sealing agent is introduced into an ampoule, and 1 ml of liquid crystal is added to it. This ampoule is placed in an oven at 100° C. for 1 hour, left and returned to room temperature (25° C.), then the liquid crystal is placed in liquid electrodes, an voltage of 10 V is applied across the electrodes, and after 10 minutes, the specific resistance (Ωcm) of the liquid crystals (cured product and liquid) is measured. In this invention, a specific resistance-measuring device from Toyo Technica, an electrometer 6517 (manufactured by Keithley Ltd.), a liquid electrode LE21 (Ando Electric Co., Ltd.) were used. In this invention, the “reduction in the logarithm of the specific resistance of the liquid crystals” is calculated according to the following formula:

Reduction (%) in the logarithm of the specific resistance of the liquid crystals=[log(specific resistance of the used liquid crystals to which the sealing agent was not added)—log(specific resistance of the used liquid crystals to which the sealing agent was added)/(log(specific resistance of the used liquid crystals to which the sealing agent was not added)]×100

Measurement Method B

0.3 g of the sealing agent is introduced into an ampoule, and 1 ml of liquid crystal is added to it. This ampoule is placed in an oven at 100° C. for 1 hour, then left and returned to room temperature (25° C.), and the liquid crystals are placed in a DSC cell and measured for their peak temperature at an increasing temperature of 10° C./min. In this invention, a thermal analyzer DT-40 (Shimadzu Corporation) was used.

The reduction in the logarithm of the specific resistance of the liquid crystals to which the sealing agent of the invention was added, as determined by Measurement Method A, is preferably 5% or less, more preferably 2% or less and most preferably 1% or less. In addition, the change in the phase transition temperature of the liquid crystals to which the sealing agent of the invention was added, as determined by Measurement Method B, is preferably 0.3° C. or less.

In a more preferable embodiment of the invention, the reductions in weight at room temperature and at 150° C., as determined by Measurement Method C below, are 0.05 weight % or less and 0.5 weight % or less, respectively.

Measurement Method C

10 mg of the sealing agent is placed in a TG cell and left at room temperature (25° C.) or at 150° C. for 1 hour, and then the reduction in weight is measured. In this invention, Thermo Plus TG8120 (Rigaku) was used.

The reduction in the weight of the sealing agent at room temperature according to Measurement Method C is preferably 0.02% by weight or less, more preferably 0.01% by weight or less relative to the original weight. The reduction in the weight at 150° C. is preferably 0.2% by weight or less, more preferably 0.1% by weight or less relative to the original weight.

### EXAMPLES

Hereinafter, the sealing agent of this invention is described by reference to the Examples. However, the present invention is not limited to the following examples, and other modes than the following examples can be easily carried out by those skilled in the art after testing the used liquid crystals by the measurement methods described above.

### Examples 1 to 3

The sealing agents in Examples 1 to 3 were prepared using the components and amounts shown in Table 1 (unit: weight-%). The partially methacrylated epoxy resin used was a resin prepared in Synthesis Example in Japanese Patent Laid-Open No. 5-295087. These components are subjected to the highly purifying treatment as described below. The partial methacrylated epoxy resin was washed repeatedly with ultra-pure water until the electrical conductance of the ultra-pure water used in the final washing was lowered to a predetermined level. Finally, the resin was outgassed by treatment under reduced pressure at 2500 Pa at 150° C. for 1 hour. Epichlone 860 and 850S were outgassed by treatment under reduced pressure at 2500 Pa at 150° C. for 1 hour. ACR Epoxy R-1415 was washed repeatedly with ultra-pure water until the electrical conductance of the ultra-pure water used in the final washing was lowered to a predetermined level. Finally, the resin was outgassed by treatment under reduced pressure at 2500 Pa at 150° C. for 1 hour. Dicyclopentynyl acrylate was distilled at 160° C. under reduced pressure at 133 Pa. Bisphenol A dimethacrylate was washed repeatedly with ultra-pure water until the electrical conductance of the ultra-pure water used in the final washing was lowered to a predetermined level. Finally, it was outgassed by treatment under reduced pressure at 2500 Pa at 150° C. for 1 hour. Amicure-VDH was dissolved by heating in methanol, filtered through a 300-mesh filter, re-crystallized and dried at 60° C. under reduced pressure at 133 Pa.

TABLE 1

| | Example 1 | Example 2 | Example 3 |
|---|---|---|---|
| Partially methacrylated epoxy | 0 | 40 | 40 |
| resin | | | |
| Epichlone 850S | 15 | 15 | |
| Epichlone 860 | | | 15 |
| ACR Epoxy R-1415 | 5 | 5 | 5 |
| KR-02 | 2 | 2 | 2 |
| Amicure-VDII [VDII] | 16 | 16 | 16 |
| SS-15 (Osaka Kasei Silica) | 20 | 21 | 21 |
| KBM-403 | 1 | 1 | 1 |
| KBE-1003 | 1 | | |
| Viscosity (mPa · s) | 350000 | 350000 | 900000 |
| Bond strength | | | |
| Ordinary state | 11.7 | 9.8 | 9.8 |
| After PCT20H | 19.6 | 19.6 | 20.6 |
| Electrical conductance of | 10.0 | 9.8 | 9.5 |
| extracting water (μS/cm) | | | |
| Outgassing at 150° C. (%) | | | |
| Cured product | 0.1 | 0.05 | 0.05 |
| Liquid | 0.1 | 0 | 0 |
| Outgassing at room | | | |
| temperature (%) | | | |
| Liquid | 0.02 | 0 | 0 |
| Change in Ni point | | | |
| Cured product | 0 | 0 | 0 |
| Liquid | 0.3 | 0.3 | 0.2 |
| Specific resistance of liquid | | | |
| crystals (Ωcm) | | | |
| (Blank 1.9E13) | | | |
| Cured product | 1.5E13 | 1.5E13 | 1.7E13 |
| Liquid | 1.5E13 | 1.5E13 | 1.6E13 |
| Reduction in logarithm of specific | | | |
| resistance (%) | | | |
| Cured product | 0.8 | 0.8 | 0.4 |
| Liquid | 0.8 | 0.8 | 0.6 |
| Panel test on abnormality in | ◯ | ◯ | ◯ |
| orientation | | | |

Now, the method of producing panels by using the sealing agents obtained in Examples 1 to 3 is described. First, as shown in step \mathring{1}, the sealing agent in each of Examples 1 to 3 (just before use, the gapping agent PF-50 (5 μm) was added in an amount of 1% by weight) was applied with a dispenser onto a glass to form a coating of 0.3 mm in width and 30 μm in height on the glass. Thereafter, as shown in Step \mathring{2}, the liquid crystal (ZLI-4792) was dropped in a predetermined amount, and thereafter, as shown in Step \mathring{3}, the glass was attached to another glass under reduced pressure (13.3 Pa). Thereafter, as shown in Step \mathring{4}, the attached product was taken out from the atmosphere under reduced pressure and then gapped for a few minutes to give a 5 μm gap between the glasses. Thereafter, as shown in Step \mathring{5}, the product was irradiated with UV rays (2000 mJ) and heated at 120° C. for 60 minutes without using a clamping jig, to give a panel.

The resulting panel was examined for its bond strength and for its abnormality in orientation according to known methods. The results are shown in Table 1. The sealing agent of this invention is suitable for production of LCD panels such as low-voltage-driving TFT panels and vertically oriented TFT panels.

What is claimed is:

1. A sealing agent for Liquid Crystal dropping method for LCD panels which comprises a photosetting component, a thermosetting component and a photosetting agent, characterized in that the reduction in the logarithm of the specific resistance of liquid crystals as determined by Measurement Method A described in the Detailed Description of the Invention is 8% or less, and the change in the phase transition temperature of the liquid crystals as determined by Measurement Method B in the Detailed Description of the Invention is 0.5° C. or less.

2. The sealing agent according to claim 1, characterized in that the reductions in weight at room temperature and at 150° C. as determined by Measurement Method C described in the Detailed Description of the Invention are 0.05 weight % or less and 0.5 weight % or less, respectively.

3. A LCD panel manufactured by using the sealing agent according to claim 1 or 2.
